(19) United States
(12) Patent Application Publication
(10) Pub. No.: US 2019/0266622 A1
(43) Pub. Date: Aug. 29, 2019

(54) SYSTEM AND METHOD FOR MEASURING AND PREDICTING USER BEHAVIOR INDICATING SATISFACTION AND CHURN PROBABILITY

(71) Applicant: THINKCX TECHNOLOGIES, INC., Langley (CA)

(72) Inventors: Donald R. Turnbull, Vancouver (CA); Derek Muxworthy, Langley (CA); Aaron David Nielsen, Langley (CA)

(21) Appl. No.: 16/288,014

(22) Filed: Feb. 27, 2019

Related U.S. Application Data
(60) Provisional application No. 62/635,727, filed on Feb. 27, 2018.

(51) Int. Cl. G06Q 30/02; G06N 5/04; G06N 20/00

(52) U.S. Cl. CPC G06Q 30/0202; H04W 4/02; G06N 20/00; G06N 5/048

(57) ABSTRACT

A method includes electronically gathering, from at least one independent data source, a set of data points, wherein the data points comprise information about the behavior of a population of mobile-device customers and potential mobile-device customers. A numerical score for the mobile-device customer or potential mobile-device customer is determined based on the information. The determined numerical score is compared to one or more predetermined numerical thresholds, and based on the comparing, the mobile-device customer's or potential mobile-device customer's likelihood to churn and whether the mobile-device customer or potential mobile-device customer should be the target of emphasized marketing efforts is determined.

### PRIORITY CLAIM

This application claims the benefit of U.S. Provisional Application No. 62/635,727 filed Feb. 27, 2018. The above-referenced application is hereby incorporated by reference in its entirety as if fully set forth herein.

### BACKGROUND OF THE INVENTION

The problem of customer churn is a significant issue in the telecommunications or telecom industry, particularly in the United States where product penetration is very high and there is a declining pool of available customers who are new to the technology. On the wireless carrier side of the telecom marketplace, average monthly churn rates for the major service providers ranges between 1-2%. That means that a median of about 18% of their subscriber base leaves each year, representing approximately $9.72 billion in lost lifetime customer value for a Sprint- or T-Mobile-sized carrier annually. With the high cost of replacement, customer acquisition in this space (ranging from $350-$720 per new customer), there is a lucrative business case for reducing churn, and so telecoms continue to search out new solutions that proactively address churn.

Over the past decade or so, companies experiencing the pain of churn have begun to deploy systems and processes that identify and communicate proactively with at-risk customers. These solutions are driven by data mining and analytics of the telecom's own structured internal data.

Currently, applications and services, both internally to telecommunications service providers and via external vendors have only limited measurement and accuracy to determine customer churn because churn data is difficult or impossible to obtain and if obtained, is often inaccurate or incomplete. Current solutions do not rely on behavioral data from diverse sources about a customer, but are based on common metrics or thresholds such as near end of a customer contract or device usage measured for billing purposes (e.g., amount of data used and call location). These broad metrics don't rely on direct (or directly derived and predicted) data from a customer and have little correlation to external data from outside the telecommunications service providers' own data on the customers. The use of these metrics is also limited in tracking, for example, when a customer started shopping online but purchased offline at a store location or over the phone. For example, there are currently no comprehensive services that can link an information seeking episode where searches, apps or advertising are seen by a customer, with real-world activities such as visits to a store or with a customer service call.

While there are many studies into how mobile device users work and play with their devices, mobile advertising effectiveness, and general mobile device shopping and purchasing behavior, there is little current empirical insight into the holistic view of a mobile device customer as an individual in an information seeking context. In terms of understanding and predicting the customer churn behavior associated with this information seeking behavior, there is little present awareness in associating a mobile device and mobile device linking to learn about behavior at all, not to mention in near real-time or on-demand.

### BRIEF DESCRIPTION OF THE DRAWING FIGURES

Preferred and alternative examples of the present invention are described in detail below with reference to the following drawings:

FIG. 1 illustrates, according to an embodiment, at the highest level, how two possible sets of raw data (bid stream and device data) are processed generally for the purposes of churn detection;

FIG. 2 illustrates a second layer of the churn solution detection system according to an embodiment;

FIG. 3 provides further detail about the task of making a lookup table for the Mobile Advertising ID (MAID) to both the device model and the carrier, according to an embodiment;

FIG. 4 illustrates features used, according to an embodiment, when predicting the device's primary service provider (carrier);

FIG. 5 illustrates one possible “Find Clusters with New Device” sub-process of the system according to an embodiment;

FIGS. 6A-6C illustrate a general process flow, according to an embodiment, to generate device features that are a source for the churn detection machine learning model;

FIG. 7 illustrates A next step, according to an embodiment, of the primary Churn Detection Model;

FIG. 8 shows, according to an embodiment, a process to “clean” the churn set and ensure that the results and output format is consistent between churn analysis batches and to ensure that the model and the machine learning classifier are working with consistently uniform data;

FIG. 9 illustrates receiving data from one or more pixels on a client's website or ad impressions and integrating this data into the system according to an embodiment;

FIG. 10 illustrates a data flow and the data and table structures for logging the cookie visits that are contained in the DeviceClusterGraph, according to some embodiments;

FIG. 11 illustrates the final step of a Client Web Solution, according to an embodiment;

FIG. 12 illustrates an example, according to an embodiment, of a process of gathering the website data and attaching it to the churn predictions that have been detected; and

FIG. 13 illustrates a “Telco Dashboard” according to an embodiment.

### DETAILED DESCRIPTION OF THE INVENTION

### Glossary of Terms

Bid Request: Data packet that describes an ad impression being auctioned by a web site or app.

Bid Stream: Collection of bid requests received in a real-time stream.

Cluster Graph: User graph containing all the devices linked together by a partner data provider.

Cluster Date: The date which the weekly cluster graph was made available.

Churn: User/Device that has changed carrier.

Entity Classes: Devices, Clusters, and Churn pairs data structures.

Entity Parameters: Flattened representation of the bid stream for each entity class.

Model Alias: Manufacturer's internal model number for a phone model. A model number can be produced for a specific carrier and/or region, based on the letter suffix. (e.g., SM-G950V).

Trackable Cookie: Cookie ID that has a linked mobile ad ID in the Cluster Graph.

User Agent Graph: File created by a partner data provider that has device ID key and user agent value. The coverage of cookie IDs is nearly 100% while the Mobile Advertising ID (MAID) coverage is roughly 10%.

This patent application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

Embodiments of the invention may be described in the general context of computer-executable instructions, such as program modules, being executed by a processing device having specialized functionality and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Embodiments of the invention may include or be implemented in a variety of computer readable media. Computer readable media can be any available media that can be accessed by a computer and includes both volatile and nonvolatile media, removable and non-removable media. By way of example, and not limitation, computer readable media may comprise computer storage media and communication media. Computer storage media include volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by a computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. In some embodiments, portions of the described functionality may be implemented using storage devices, network devices, or special-purpose computer systems, in addition to or instead of being implemented using general-purpose computer systems. The term “computing device,” as used herein, refers to at least all these types of devices, and is not limited to these types of devices.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

The present disclosure relates generally to the practical application of customer behavior prediction based on a set of data types including a machine-learning algorithm to classify and predict customer behavior likelihoods, which in turn leads to the practical application of identifying those customers or potential customers who should be the targets of emphasized marketing efforts.

Mobile device customers subscribe to telecommunications service providers to have access to voice and data services with smartphones, tablets and other computing devices. Subscriptions have common characteristics that can be modeled such as length of contract, quality of service, usage tracking and caps, device rebates or discounts, and lifetime value. These characteristics are comparable across competitive service providers while changes in price, service quality, and usage vary over contract commitments and with capabilities of the device(s) in a service contract. Currently, a customer's contract characteristics are primarily how each service provider measures a customer's value and makes broad predictions about a customer's decision to keep a service provider or churn to another provider.

Service providers currently analyze their own internal data about an existing customer and often utilize mass market format re-subscription or other incentive offers to keep customers. Service providers, when possible, also use in-store advertising and salespeople to make incentive offers and apply some judgement to customizing an additional offer to a new or existing customer. Some limited customized advertising or offers based on general customer attributes or demographics may be shown to a customer when using the service provider's web site, with additional customization if a customer logs in to an account or otherwise identifies themselves to the service provider. However, even these limited examples do not account for other relevant information about a (potential) customer, which may include for example, their behavior towards the service provider, their propensity to look at other service providers, their (perceived) quality of service and other indicators that are presently outside of the service provider's domains of knowledge via limited contact with a customer. This approach offers value to a service provider—however, having a deeper set of contextual indicators about a customer's behavior and characteristics will increase knowledge about a customer's satisfaction, which may be measured in one form, according to various embodiments described herein, as a propensity to churn.

When using their device, customer(s) may engage in information seeking behavior. This behavior can include, for example, an explicit effort to browse, search, and review information related to events of interest, including, for example: switching service providers, upgrading a device, pricing, and other related criteria. This behavior can be recognized programmatically using a set of hard-coded rules (e.g., keyword matches, known URLs, etc.) that can provide a great deal of insight into a person's information seeking behavior related to a device, a service provider, and plan and pricing information. The context of the behavior can provide additional insight, including at the least a more probable indicator of potential service provider churn. There are many solutions that rely solely on these hard-coded, pre-defined rules such as temporally-based indicators of interest over time, in other related contexts (e.g., changes in locations), or event-driven indicators including changes in service provider competition, etc. The described systems and techniques improve on these methods to provide an algorithmically-driven, contextual model of customer satisfaction with a service provider, where a learning model (for example, a random forest method) accepts device, user, carrier, bid and other usage features and outputs one or more metrics for a device, where the one or more metrics indicate a probability of churn.

The systems and techniques described herein expand a network service provider's customer insights by using a wide variety of relevant signals not combined or analyzed in any previously-known systems. In various embodiments of the present disclosure, churn prediction is carried out by tracking mobile devices determined by the system as unique mobile device identifiers, classifying these unique devices into clusters, and using customer behavioral indicators from advertising bid stream information, and third-party application usage, as a gauge of behavioral interest. In this exemplary embodiment, the predictive process has multiple steps including: identifying the unique device, associating that device to a customer, detecting customers as churn candidates, and predicting churner likelihoods based on absolute, or an adjustable, relative scoring method which makes the precision and recall tunable for the result set based on the client needs. For example, a client building a digital advertisement audience requires the result set to be tuned for high recall and less precision whereas client doing industry trend analysis requires tuning which delivers high precision and less recall.

According to various embodiments of the present disclosure, a set of acquired, parsed, and cleaned advertising bid stream and application usage data is collected as an initial method to detect mobile device user behavior. This behavior can include, for example, situations where a user stops using a device on a cellular network, starts using a new device, switches to a new carrier, and other environmental indicators of mobile device user behavior by the identified user(s). Machine learning methods, the simplest instance being supervised learning with a random forest model for classification, may then be used to predict whether a uniquely identified mobile device customer will be a churner in the near future. The output of this process is a value pair. According to the various embodiments, the value pair consists of a label and confidence score. The label is, preferably, but not limited to, a code indicating “churn” or “not churn.” The confidence score indicates how accurate the machine learning model predicts based on empirical pre and post-hoc data verification.

One specific challenge addressed by the present disclosure is that bid stream data is vast. For example, current systems can accumulate more than 1 billion rows amounting to approximately 1 TB of bid stream data daily. It is difficult and computationally expensive to process, sort, organize (in a database for example) and query this scale of data in any traditional information system manner such as with SQL. Therefore, the present disclosure may utilize, for example, machine learning methods to predict whether a uniquely identified mobile device(s) customer will be a churner in the near future, without having to process all of the available data. This may reduce the computational load and expense.

In various embodiments, data may also be aggregated and dimensionally reduced per the algorithm requirements. As data is distilled and further analyzed for quality signals, datasets can be reduced (summarized) or updated only when significant differences are detected, saving time and computational effort. Even where the data is reduced, data may still be stored and used in other potential methods including other distinct algorithms or as algorithms and machine learning methods improve over time.

Mobile devices themselves can be classified, for example, at minimum by user agent identifiers, as well as other supplementary mobile device characteristics including screen size, operating system version, model release date, price and other known or derived characteristics of a particular mobile device type or class of mobile device types. The present disclosure may utilize, for example, a database of information to cross reference the classifications to determine the mobile device(s). For example, a Device Model Dictionary may be used. The Device Model Dictionary may be derived from a number of external data sources, and can help identify specific mobile devices and their associated feature sets, common carrier, network protocols and varied user agent strings.

Information used in various embodiments of the present invention may be stored according to known methods, such as on local hard-drives, the cloud, RAM, on a distributed system, or any other means known in the art. In various embodiments, data may be moved from passive storage to active storage as necessary. For example, active storage may utilize more rapid memory modules, which may provide quicker access and enable increased computational speed.

The present disclosure may also identify a taxonomy of, and classification of, a set of devices that belong to the same person. The cluster can consist of a single currently-used mobile device, but additionally the cluster may be derived from potentially more than one device based on a technique called “device linking,” for example. According to the present disclosure, the majority of device linked sets consist of, for example, identifying characteristics of multiple devices, the tracking and associating of multiple cookies, as opposed to mobile devices representing customers with single cookies, or “orphaned” cookies. The described methods of churn detection may determine the device linked cluster in the initial step.

According to the present disclosure, the acquired, cleaned and parsed bid stream data may be used in at least two steps, for example: to detect a new primary device and to measure and determine that a previous device in a device linked cluster has likely become an old or secondary device. Where it is determined that a device is an old or secondary device, that may result in less descriptive or predictive influence (but is not ignored) in determining a churn probability.

According to some embodiments of the present invention, the system and method used to measure and predict mobile device customer churn probability iterates upon the machine learning system's gradual improvement as more data is added and processed. In some cases, the new data may include new signals and updated environmental data, user behavior insights that are discovered through heuristics or the machine learning process, and so on. Heuristics may be specific to a timeframe of the datasets, the specific business need or other experience learned throughout the process about machine learning method effectiveness or about data quality and customer goals. The system and method therefore, results in a growing, fine-grained database of uniquely identified mobile devices and uniquely linked sets of devices that has not existed before in markets across service providers, in coast-to-coast locations and access environments. This database may be continually improved by adding additional data as described above and further enhanced by perpetually-refined interactive model analysis applied with machine learning methods that increase unique device identification, expand linked device sets and model the usage behavior of mobile device users themselves, which determines implicit intent via explicitly collected empirical data.

According to embodiments of the present invention, data is encrypted throughout the process. For example, encryption codes may be used between the input and the output, such that all of the data is protected throughout the steps of the present disclosure. Further, the output data may be decrypted at the output, allowing the client to review the results, while the rest of the datasets remain protected.

According to various embodiments of the present invention, the system may take the form of a server, or a collection of servers or computers. The server or collection of servers or computers may be linked to data input sources via, for example, the internet or various other types or implementations of one or more data networks. In other examples, data sources may be input by providing the server with access to the desired data set through other means.

In the past, there has not been a widely recognized successful approach to understanding a series of mobile device interaction behaviors over a longer arc of activities beyond binary ad displaying indicators or ad campaign selection. Moreover, understanding the longer-range set of mobile device information seeking or application use behaviors is not insightful beyond simple analytics measurement charting and comparisons. A long-sought goal of understanding customer mobile device behavior in near real-time would naturally be preferred. This timely aspect is not present in most customer analytics where an infrequently updated customer score is set, and does not represent the complex information interaction that a customer may perform and how the behavior may change over time.

Traditional prior art customer analytics systems do not routinely have a method to determine a customer's potential migration pattern from one mobile device to another, from one environment (location) to another, or other behavioral characteristics that upon subtle behavioral analysis of all of the combined signals, show trends in usage that can be classified as either actual indicators of impending customer churn or probable “switch” events that the system recognizes as notable and actionable by a telecommunications service provider.

The present disclosure is directed to systems and techniques for developing and using a model to understand and determine contextual behavior such as seeking information about other mobile devices (e.g., “the next iPhone”), other mobile device plans, alternative service providers, and other contextually-related behaviors. The system and methods disclosed herein are unique and advantageous compared to past applications. The described systems and techniques in part use a unique set of data sources that would not be typically available internally as data at a service provider, and include a diverse selection of multi-device datasets. These datasets can include data from various environmental sources, previously unrelated vendor data (e.g., advertising interaction data), and one or more machine learning algorithms to correlate and determine labels based on a taxonomy of consumer mobile device behavior and contextually-related indicators.

Currently, there is no alternative to the described approach herein. Further, and more importantly, the measurement and predictive results of the system and method, according to the embodiments described herein, are able to encompass additional data types and data sets, as well as adapt to discrete machine learning algorithms and models.

In some aspects of the present invention, digital churn signals may be advantageously monitored and detected to indicate churn. Digital churn signals may include, for example, a visit to a competitor's website, viewing and clicking on a competitor's advertisements, or visiting a competitor's store location. In some cases, multiple digital churn signals may be used to link together a sequence of churn events to inform actions to prevent churn, much earlier in the decision-making process. These and other signals or indications of churn may be an accurate predictor of likely churn events in the beginning stages of the subscriber's quest to find an alternative. The described techniques may also provide the benefits of the use and reliance on digital data, which reveals actual experiences and intentions on an individual customer-by-customer basis, reducing or negating the need to infer behaviors based on a customer's inclusion in a segment, cohort or decile. Customers do not feel and act the same, even when the most sophisticated statistical model puts them in the same category. Using individual actions of users to inform churn determinations reduces errors associated with categorical treatment of indicators. Further benefits of using these and other digital churn signals include receiving potential churn warnings from digital data, in real time. This allows for intelligent, real-time retention follow-up, with the benefit of a higher likelihood in saving customers.

In some examples, the described systems and techniques may be made up of or include several components, which are described herein according to potential, but non-limiting embodiments including sets of methods and logical steps operationalized into a system that surpasses any individual set of heuristics, application programs or machine learning steps.

In one example, a Churn Measurement Solution is generally, a heuristics-driven methodology or process comprised of a set of logical steps to detect churn candidates. Another example is a process for detecting churn including adding data to the system as described below and using post-hoc verification to examine potential churn mobile device customers over time to see if or when there are definitive signs of churn. The model in the system, according to some cases, supports this and provides, for example, a feedback loop to help improve the accuracy of identifying churn behavior, churn behavior types (as classified by the system's machine learning or rule-based components) and obvious indicators such as lack of a mobile device's usage (when associated with other linked devices).

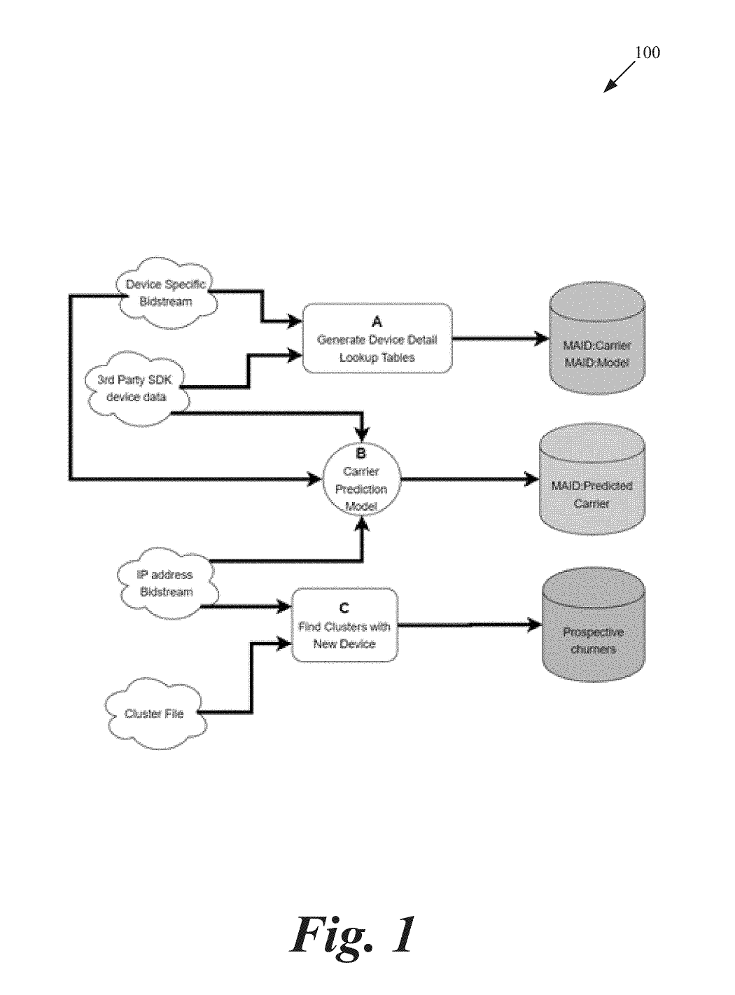

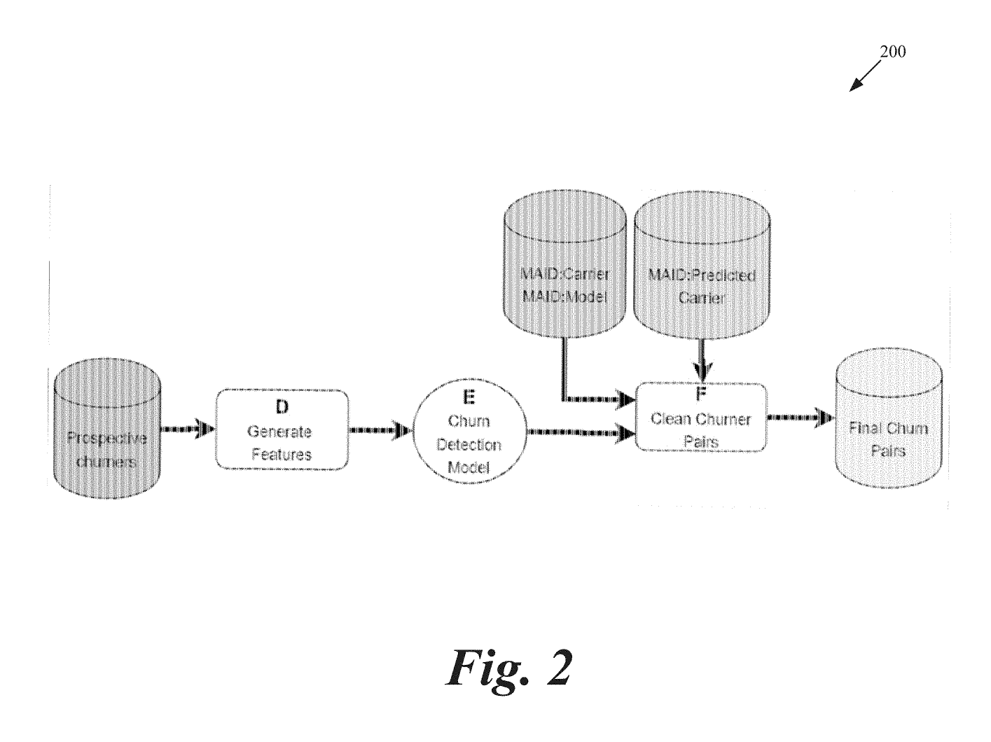

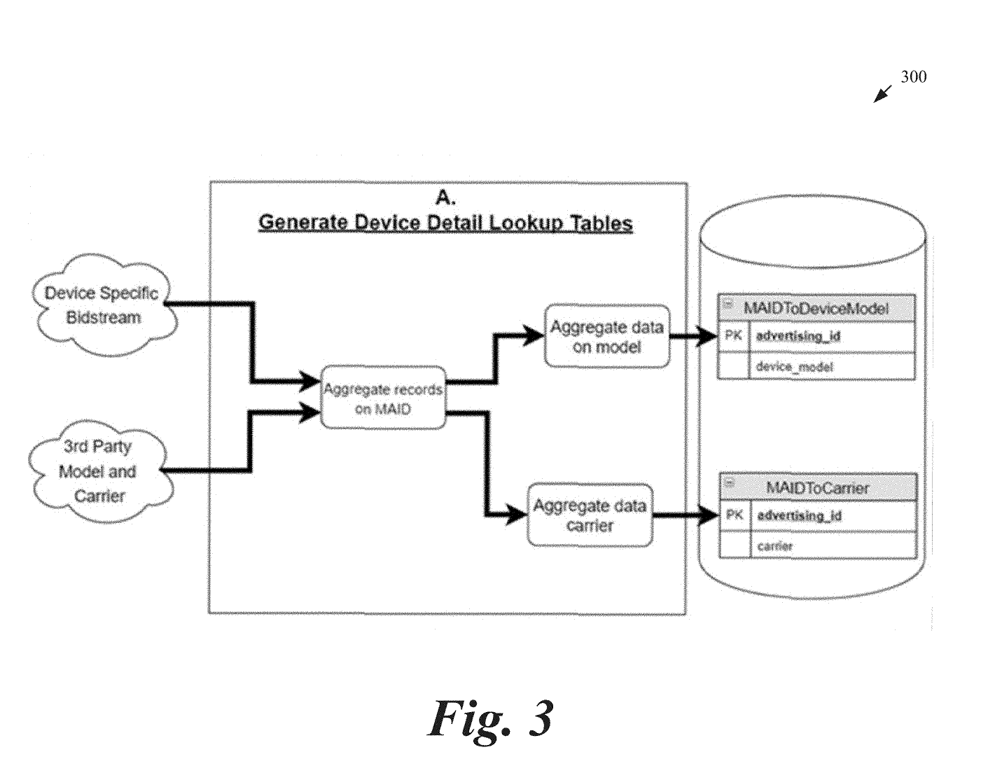

The following high-level workflow diagrams, described in reference to FIGS. 1 and 2, illustrate the flow of data from raw files to client endpoints according to one example. Each of these diagrams annotates numerically the sub-processes contained within them, and are referred to in subsequent diagrams (FIGS. 3-12). The methods described in reference to the figures feature algorithms to generate device features, device cluster (linked devices) features, carrier (telecommunications service provider) features and refined bid stream features, all actionable either individually, or in concert, as data to be processed by the machine learning algorithms. The Figures are submitted in color and best viewed in color.

FIG. 1 illustrates, according to an embodiment, at the highest level, how two possible sets of raw data (bid stream and device data) are processed generally for the purposes of churn detection. According to the depicted example, as the solution matures, there will be more data sets/sources that will be added into the process flow. The cloud icons depict the raw data made available through cloud services or network storage access protocols such as SFTP or ODBC from (external) data provider vendors and/or refined data from internal data storage. The MAID (Mobile Advertising ID) datasets, in this example, are uniquely derived from the external data sources as processed by the system. The circular sub process Carrier Prediction Model is discussed in more detail in subsequent figures.

Both FIGS. 1 and 2 depict a high-level process flow, according to an embodiment, that may be performed by the described system. Note that the clouds, as depicted in the figures, are only two examples of data sources, those that are external from vendors and represent device model and a more accurate measure of carrier (a “predicted carrier”, in the model). The described system supports the addition of other external datasets, even competing and overlapping datasets, such as bid stream data from multiple advertising sources by device, by location, or other classifiable unique characteristics that would add to the diversity of datasets and data types in an expanding model.

Location may be determined, for example, by a mobile device network location that can be added to the model to enhance prediction of customer churn probability based on geographic location behavior. Location may also be determined, for example, where geographic location data is indicated by a mobile device network Wi-Fi provider location, where geographic location data is indicated by a mobile device application tracking event, where geographic location data is indicated by a mobile device application installation, a mobile device application tracking event, or a mobile device text message (SMS or MMS). Geographic location data may indicate interest in churning or upgrading a device or service plan, for example, and can be added to the model to enhance prediction of customer churn probability based on geographic location behavior. Geographic location behavior can include, for example, where a customer is present in a service provider store or value-added reseller.

Additional data may also be provided by a mobile device text message (SMS or MMS), or email, advertisement, etc., that upon receipt or actionable intent (tapping or clicking a provided link) can be added to the model to enhance prediction of customer churn probability.

FIG. 2 illustrates a second layer of the churn solution detection system according to an embodiment. As illustrated in FIG. 2, in this second layer, churn is initially identified and detected using a machine learning model. Internal datasets described as databases in FIG. 1 (MAID: Carrier/MAID: Model, MAID Predicted Carrier, and Prospective Churners) are used as sources to the sub-processes that are the high-level components of the prediction model in FIG. 2, and show the overall refining process. The process is shown as a single flow, but, in at least some aspects, is iterative, based on updates to the external or internal datasets or other classification rules or procedures. The process as a whole leads to a resulting “Final Churn Pairs,” as depicted.

FIG. 2 also illustrates the steps of the method, D, E and F, according to an embodiment of the present invention. Steps D, E, and F indicate a general refining of the data into a reducible, more accurate set of “clean churner pairs” processed by the machine learning algorithms. These pairs may be non-unique, redundant or dated, and are processed again to provide the end dataset shown, the “Final Churn Pairs”. Though the “Churn Detection Model” is pictured as a single flow, it may be dynamically updated when data sources change, or for example, where there are shifts in market trends.

FIG. 3 provides further detail about the task of making a lookup table for the Mobile Advertising ID (MAID) to both the device model and the carrier, according to an embodiment. Each data set may contain unique types of noise and formatting of device information. Therefore, the data may be normalized before converging the data together. In some cases, two or more data sets will conflict. In order to combat this, the steps below contain logic that will intelligently select the most accurate device information by observing factors such as a device's usage frequency with a given device model or compatibility of device price and user behavior. This process is run on a periodic basis depending on data acquisition, computation load, and service provider requests. Running the process periodically may be used in order to keep the tables up to date with the incoming data and for near real-time predictions as requested by customers or to test machine learning algorithms and classification prediction accuracy. In other embodiments, the process may be run constantly, or based on a predetermined interval, or in response to one or more triggering events (request for a prediction, request to verify or determine prediction accuracy, etc.).

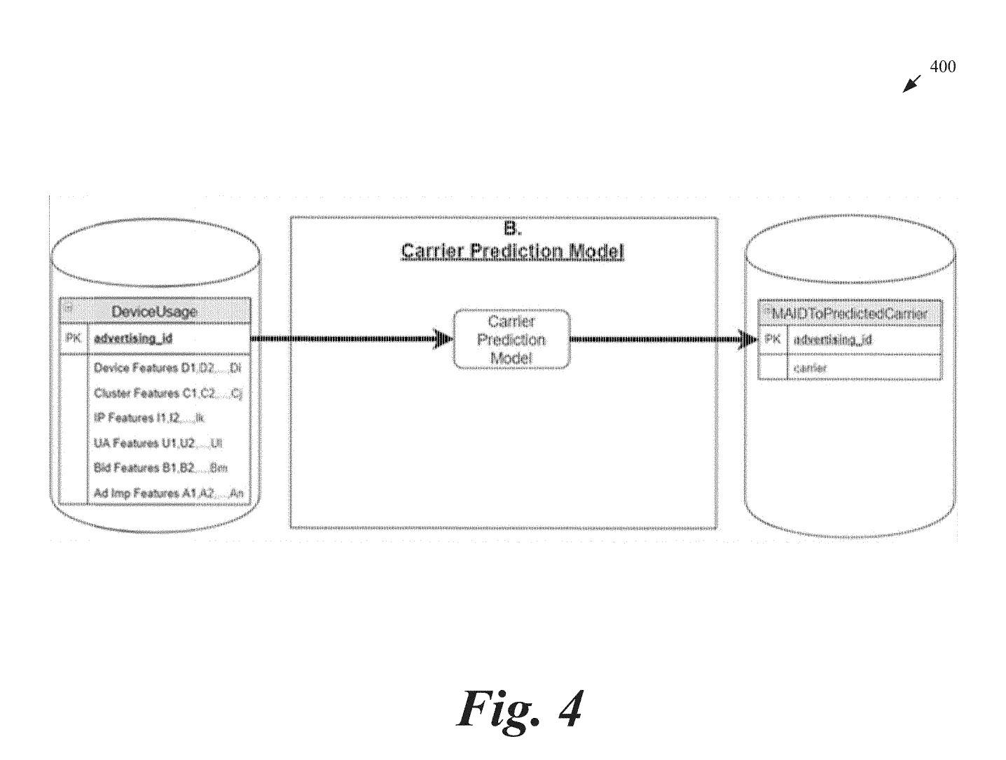

FIG. 4 illustrates features used, according to an embodiment, when predicting the device's primary service provider (carrier). Accurately determining the carrier is critical in order to avoid false churn predictions. This challenge is magnified when the primary determinant of a device's carrier is the IP address which it uses to connect to the Internet, because the IP addresses represent the mobile phone network which isn't always the same as the device's carrier. An example is that mobile virtual network operations (MVNOs) such as TracFone Wireless license network (e.g., IP addresses) are seen on IP addresses belonging to AT&T Wireless, T-Mobile and Sprint Corporation.

To accurately predict carrier, the device usage model uses numerous features including, by way of non-limiting example, IP address, carrier exclusive device models, and service provider information. This information may be extracted, for example, via an SDK in popular mobile applications. With this potential inaccuracy factored into the system's predictive capacity, the Carrier Prediction Model example described in reference to FIG. 4 is used to improve the number of devices with accurate carrier information, and iterated with new or refined data that may include additional data types beyond that shown in the DeviceUsage table or database.

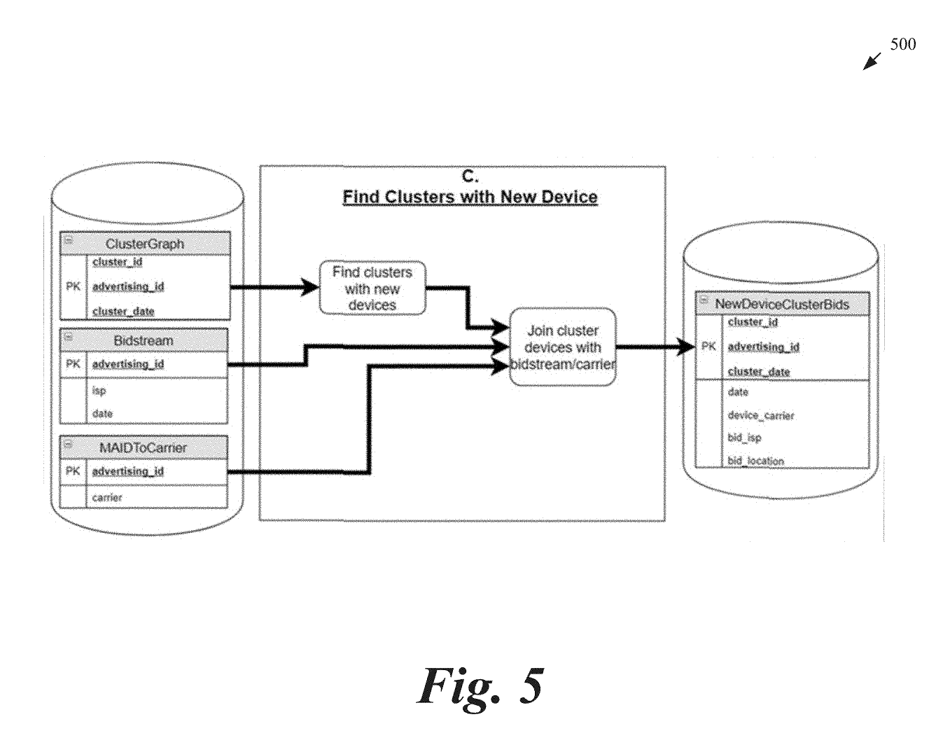

FIG. 5 illustrates one possible “Find Clusters with New Device” sub-process of the system. This sub-process may identify the possible churns for a set of devices over any set or configurable date range (daily, weekly, hourly, etc.). The historical record of a stored DeviceClusterGraph can be continually leveraged by the system and used to identify which devices are new to the graph. According to the depicted embodiment, the bid stream and carrier information is gathered together for all devices linked to the new device(s). The data that is joined with the clusters with a new device is completely variable depending on the features that are required for the churn detection model. For example, additional data sources can be added into the process to drive improvements to the end model's accuracy.

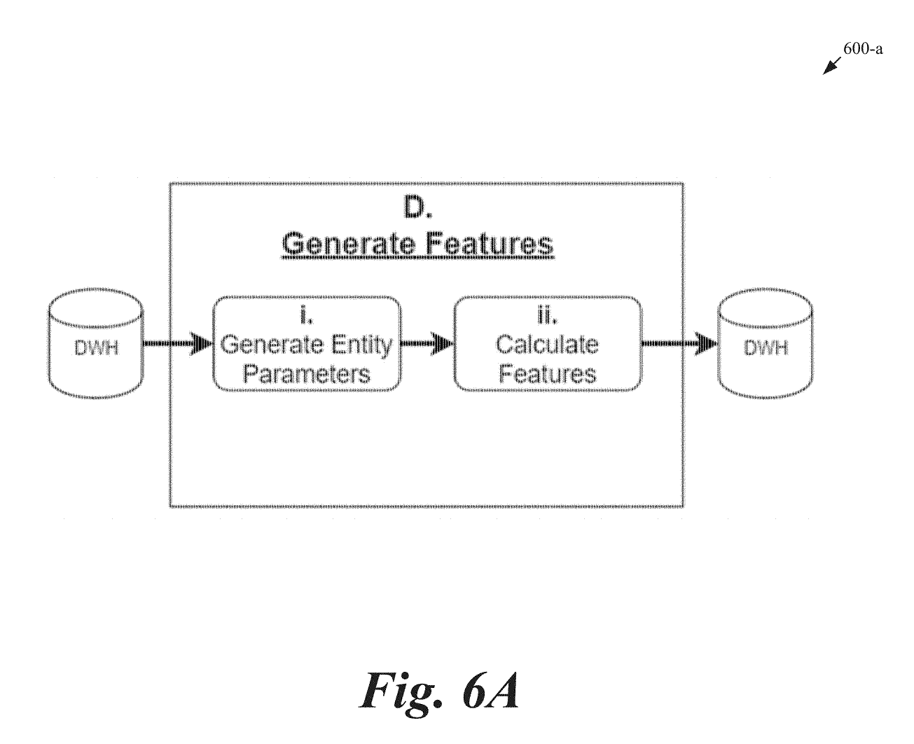

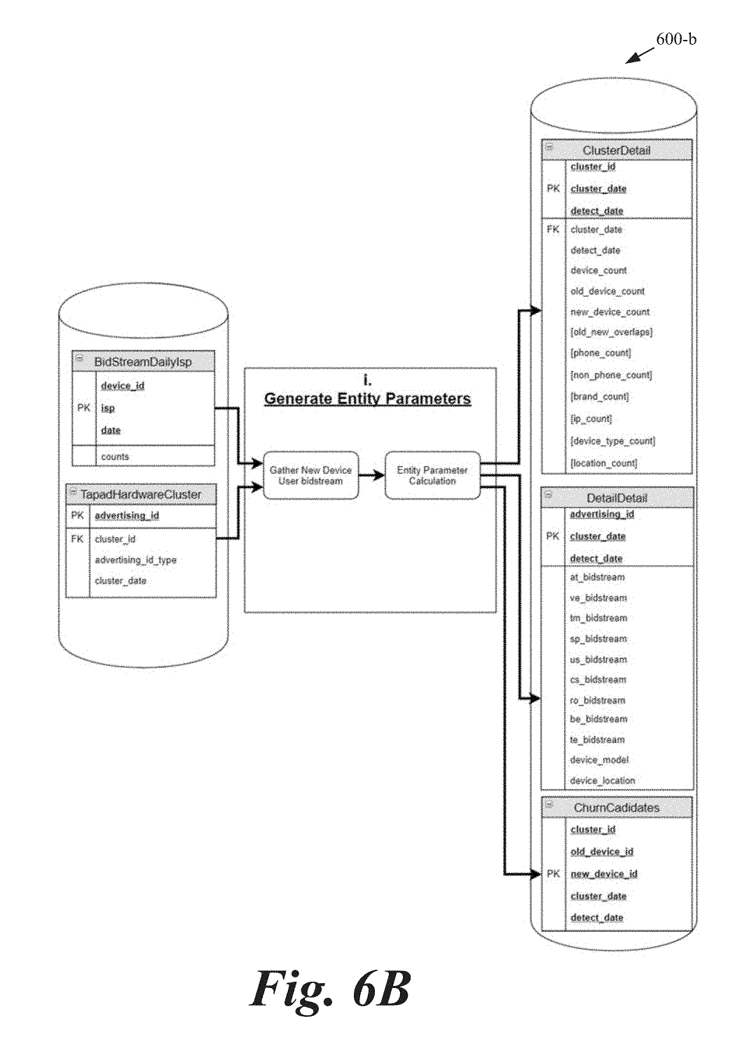

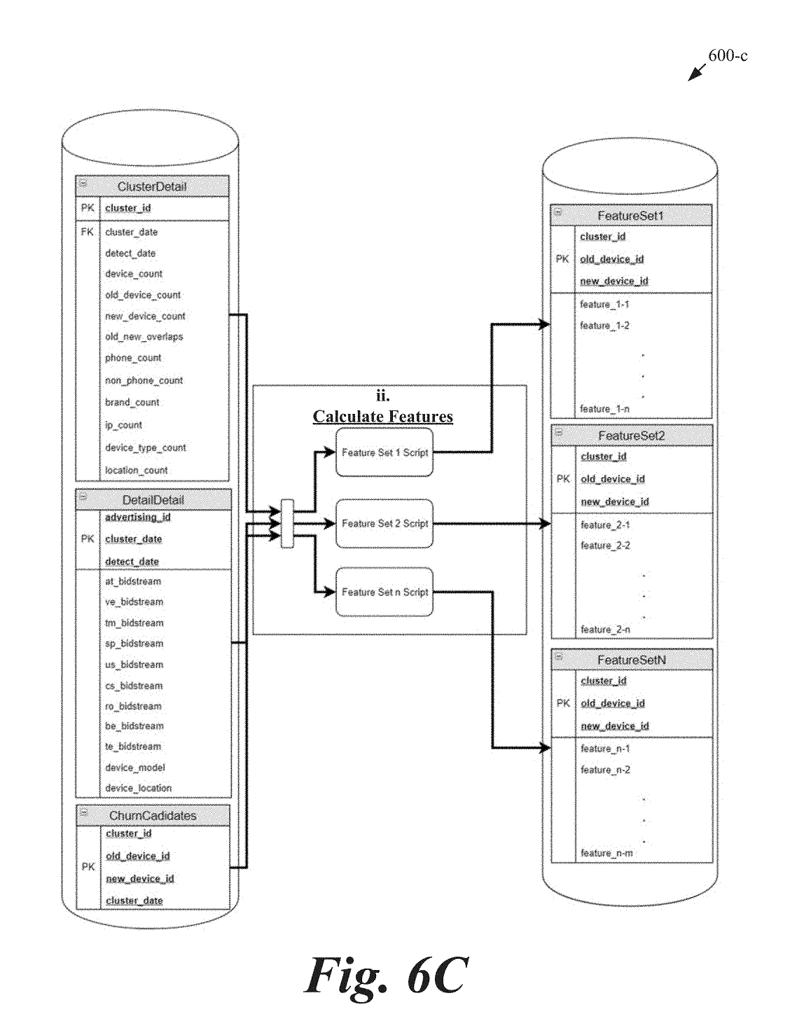

FIGS. 6A-6C illustrate the general process flow, according to an embodiment, to generate device features that are a source for the churn detection machine learning model. One embodiment of the model is supervised learning classification algorithms such as boosted decision trees. The model is trained using probabilistic churn labels defined internally and large sets of historical features from device information. The Generate Features process takes the existing data resulting from FIG. 5, now the Data Warehouse (DWH), to prepare features for the detection model. Additional explanation of the “Generate Entity Parameters” and “Calculate Features” sub-processes, can be found with reference to FIGS. 6B and 6C. Features are created using device and user behavior data. One embodiment of device behavior data is seen on the left side of FIG. 6C. The behavior data is put through a series of data transformation steps, from which any number of feature sets can be generated. The left data structure seen in FIG. 4 illustrates some of the potential feature classes that could be generated using this method. Some simple examples of specific feature calculations include partitioning device usage information into small time buckets (1-7 days), or finding the difference between the age of the old device and the switch date.

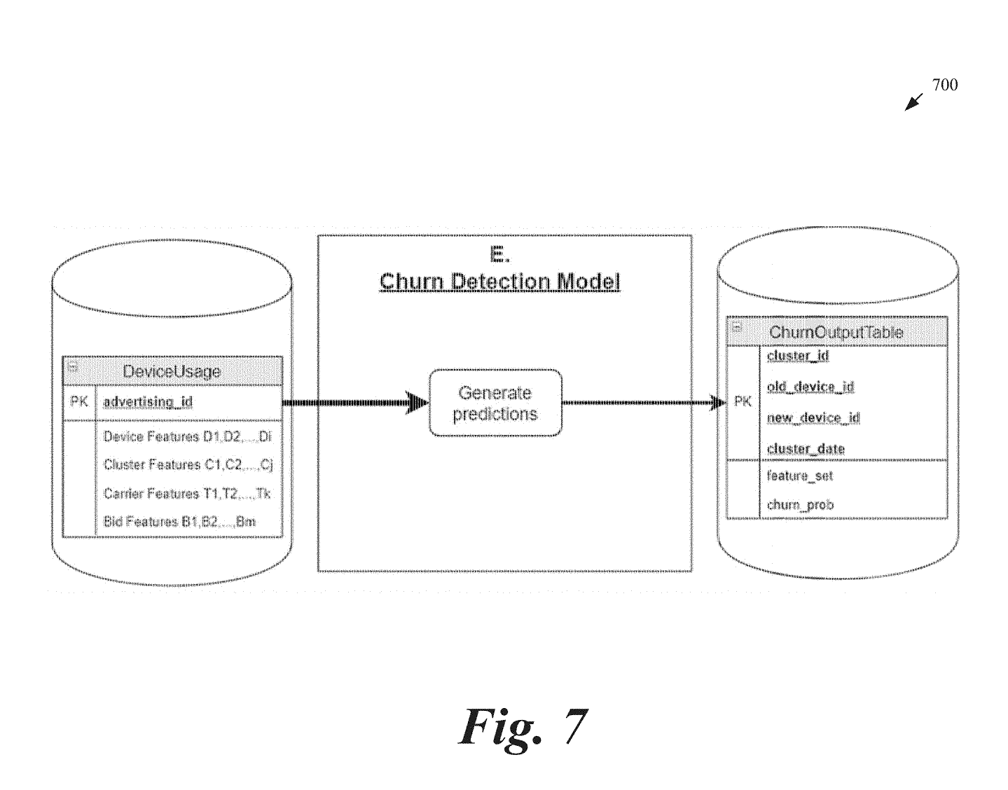

FIG. 7 illustrates the next step, according to an embodiment, of the primary Churn Detection Model. As shown, predictions are generated by the model using (in one embodiment, a boosted decision tree algorithm, or another gradient boosting machine learning technique) about the likelihood of a unique device churning, based on a set of previously processed data elements, now a refined database of DeviceUsage that is output from the Churn Detection Model and the ChurnOutputTable dataset. As previously mentioned, there is an iterative process of updating the model to keep up with market trends and data changes.

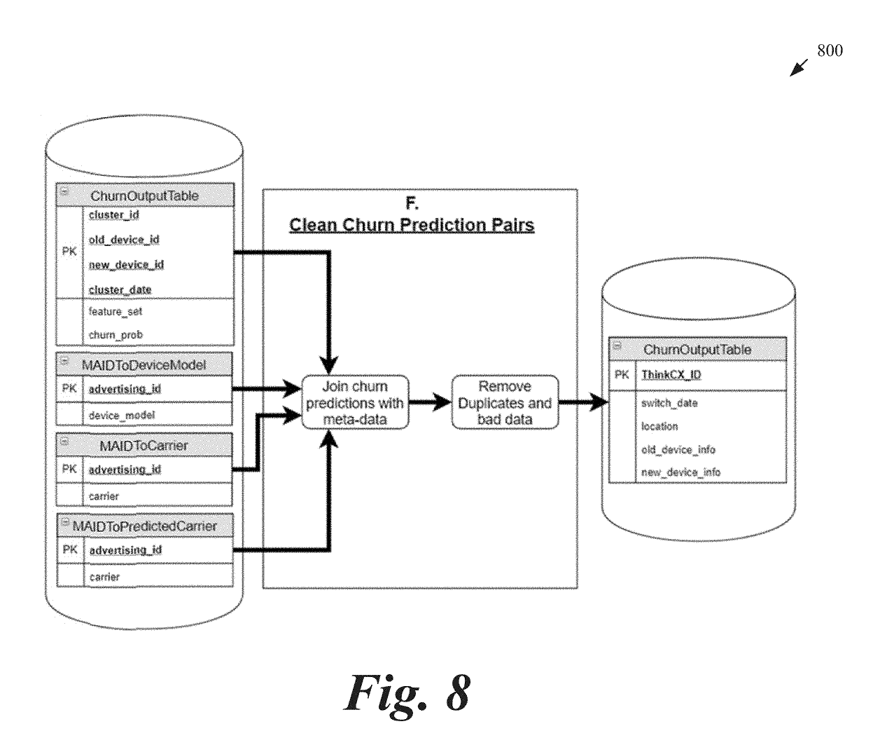

Though the detection model is highly accurate at detecting churn signals, there is still noise in the data. Therefore, one additional possible step includes processing and editing the raw datasets. FIG. 8 shows, for example, a process to “clean” the churn set and ensure that the results and output format is consistent between churn analysis batches and to ensure that the model and the machine learning classifier are working with consistently uniform data. The various data types shown are cleaned to be consistent with the required format (e.g., cluster_date: the date must be fully normalized as date values, such as into the format MM/DD/YYY; advertising_id must be consistent across data collection to ensure accuracy, one-to-one mapping, and normalized structure, such as including all the same characters, deleting or converting certain characters, etc.). This process aids in recognizing and refining artifacts in the data to continually improve the data extraction, transformation and loading (ETL) process which includes this cleaning. From a high level, data normalization may include receiving data for a certain field or type (date, advertising ID, etc.), locating or determining a standard format for the data, then modifying the data to conform to the standard format. Bad data may be identified based on a comparison with the standard format, compared to other data to determine if it duplicates other data, is unrecognizable via internal or external verification means (e.g., a web search and the like), etc. The labelling of bad data may be based on insights into carrier and device market usage behaviors, for example, tracked by the system. In one example, the system may track and generate insights through in depth analysis of carriers, device models, and the market relationships between each carrier and model. For example, certain device models may be linked to certain carriers, based on certain time periods. The data may then be examined to determine if it matches these links (e.g., a device model is linked to a carrier that actually supports that device model, etc.), and if not, it may be discarded. In one implementation, 30 carriers, and more than 1000 device models were studied to determine these insights. The market analysis may be performed on an ongoing basis to ensure that the accuracy of the final churn pairs is maximized. The system may also include, according to various embodiments, a “Client Web Solution” that leverages the output of the churn measurement solution (final churn pairs), and builds on existing standard Web browser tracking capabilities, which at least some of which are well known in the industry.

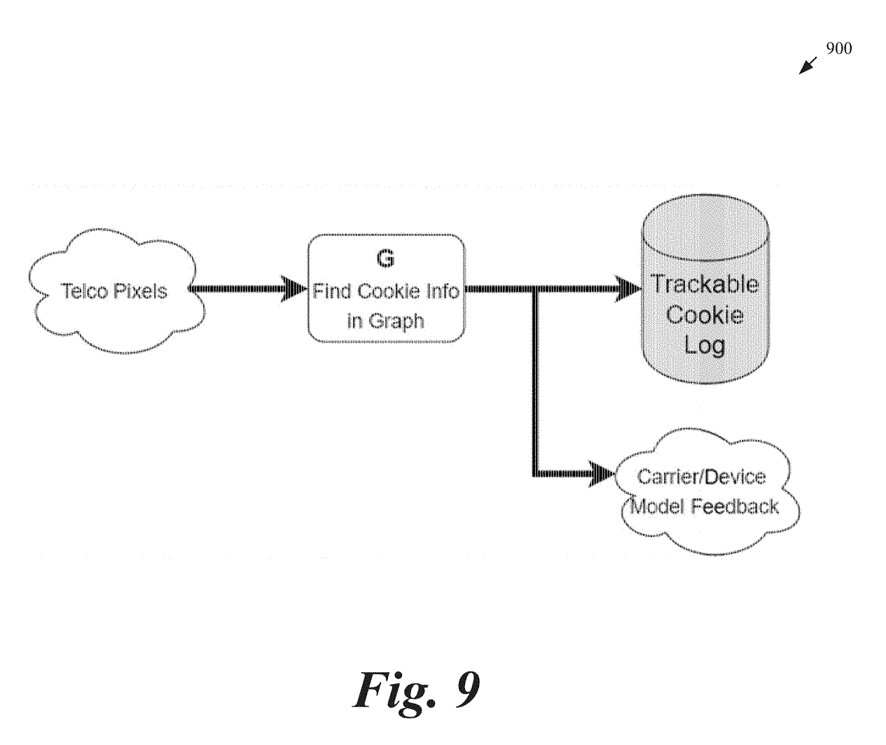

The system described herein extends these ideas with a method that includes, but is not limited to, receiving data from one or more pixels on a client's website or ad impressions and integrating this data into the system as shown in FIG. 9. The “Telco Pixel” is data indicating that a cookie or mobile device unique identifier has visited the telecommunications service provider's website or been exposed to a digital advertisement. The pixel can be linked to an associated unique mobile device identifier, which can be either matched to an existing identifier (as shown in FIG. 5) or added as a new unique mobile device identifier. Upon request, the system can send information (“feedback”) about the device as determined from the system's device cluster identification database that can include mobile device model and mobile device service provider (carrier). This data is then potentially associated with the cookie data from a log externally acquired by vendors (e.g., the bid stream dataset) from the DeviceClusterGraph, which is leveraged to send the carrier and model for a device associated with the cookie.

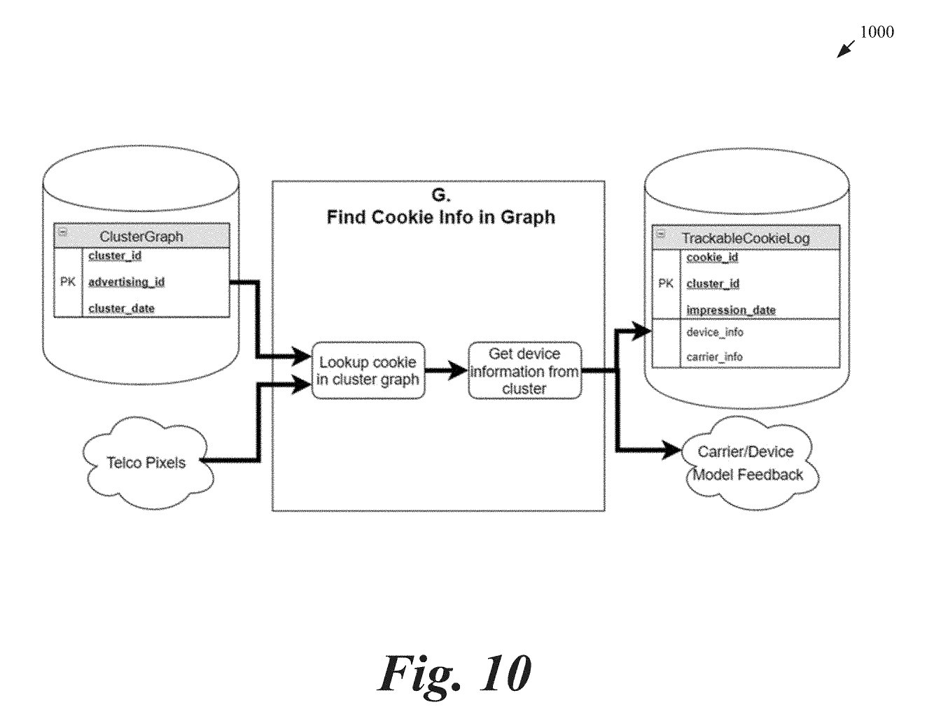

FIG. 10 illustrates a data flow and the data and table structures for logging the cookie visits that are contained in the DeviceClusterGraph, according to some embodiments. These cookies are visible and thus, their behavior can be tracked to identify churn, renewal, and other events. The cleaning process takes, for example, the multiple inputs from the (Device)ClusterGraph and Telco Pixels, removes devices with unstable cookies and devices with low web traffic visibility, and then pairs the data with the TrackableCookieLog data resulting in the delivery of the “feedback” data to the client as needed by the system or upon request.

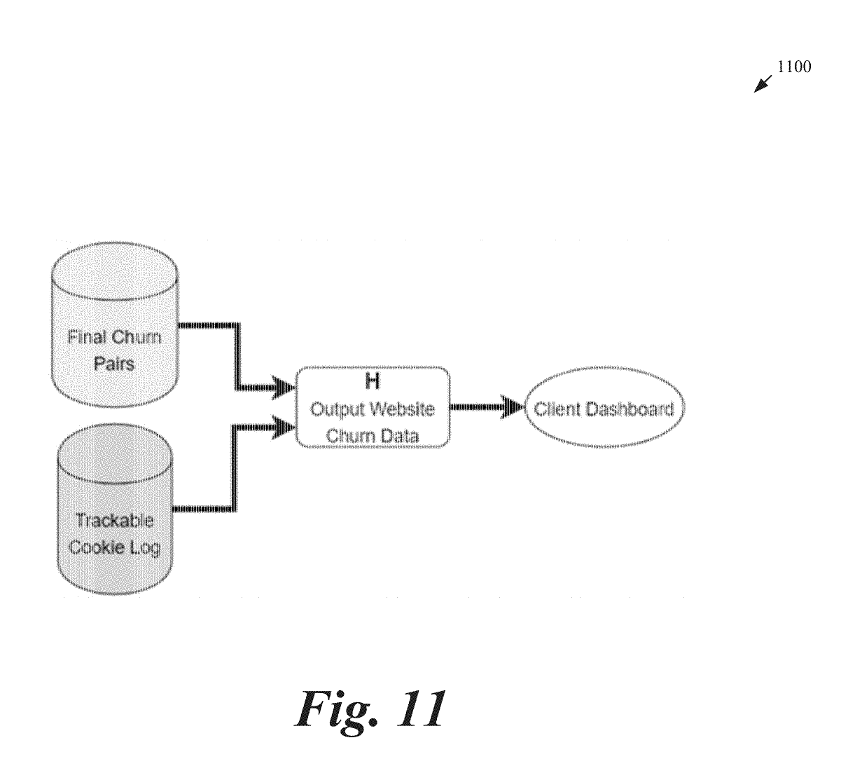

The final step of the Client Web Solution, according to an embodiment, is illustrated in FIG. 11. The final step involves joining together the cookies and other indicators contained in the DeviceClusterGraph with the unique mobile device identifiers that match with the visiting cookie. Finally, the data is outputted onto a client dashboard as configured by the client. In alternative embodiments, further processing may be necessary or desired based on client specific requests, or according to other rules set by a user or the system. For example, the client may wish to only see churn data that meets a certain threshold (e.g., a certain likelihood of churn). Or, alternatively, a user may actively seek churn data from a preferred source, a competitor, for example, that is being targeted. In that case, the user may customize the output, or the dashboard, to provide that information, in addition to the total output, or instead of the total output. Further, in various embodiments, the system may include graphics processing components or capabilities, such that the system may provide the client with a GUI, connected to the system, which allows the client to interact with the system. In other embodiments, the system may send the output data to a client computer, and thereafter the client computer may use graphics and processing components to translate the output data into a format displayed to the user in a GUI.

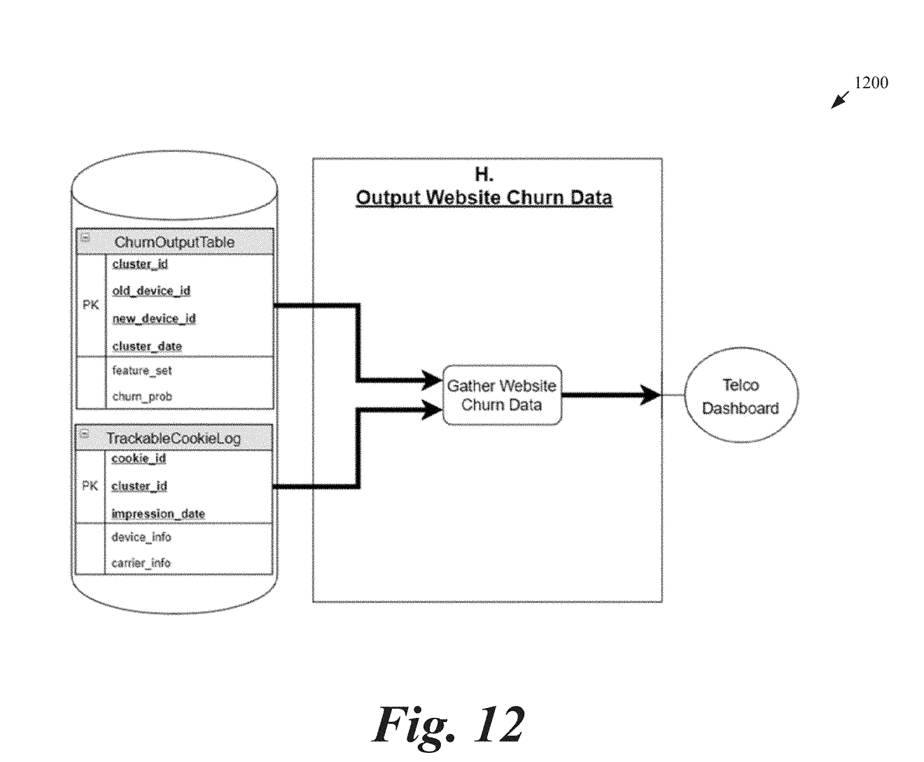

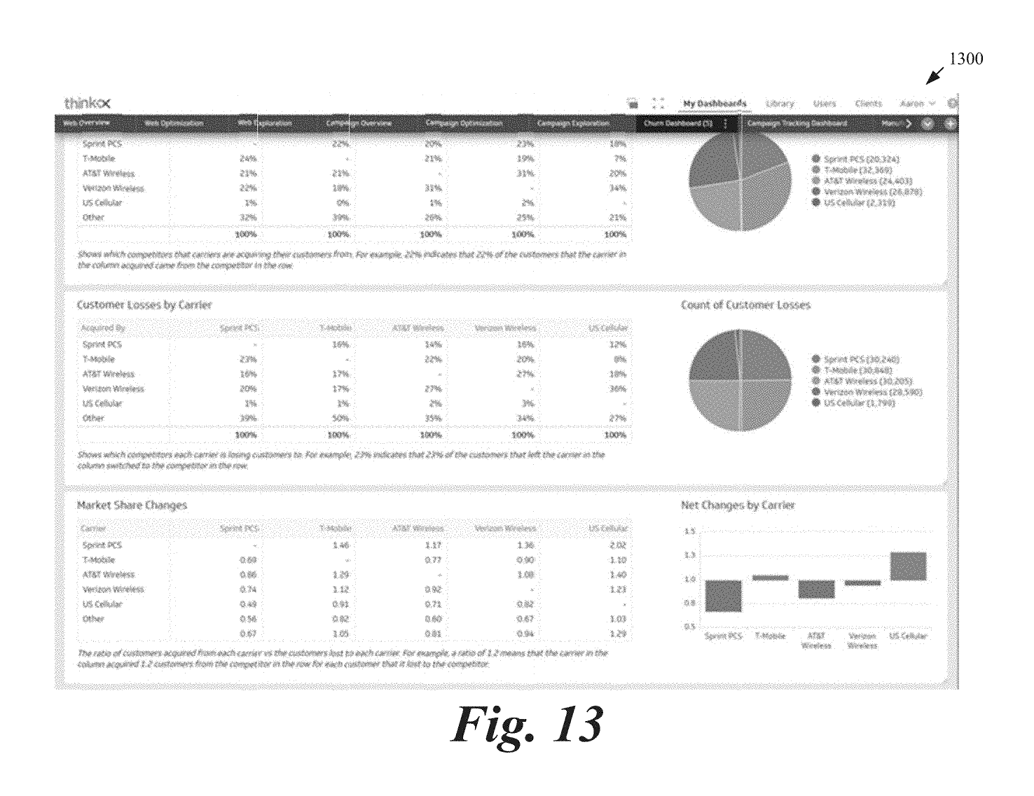

FIG. 12 illustrates an example, according to an embodiment, of a process of gathering the website data and attaching it to the churn predictions that have been detected. This data is delivered to the client. This is demonstrated in FIG. 13 as the “Telco Dashboard” 1300. Since the database is traditionally-stored data, as more data types are added, it is possible to enhance the SQL methods to increase performance or utility. The inlet data from the Telco Pixel is variable in the amount of information that is supplied to the system. Clients decide how sophisticated they would like the dashboard insights to be by choosing which information to include in the pixel. In various embodiments of the invention, a client or user can actively select and deselect data input types, ranges, or time periods. In this way, they can customize the results if so desired. This may be accomplished at the user interface, for example.

The Churn Measurement Solution described here, according to an embodiment, may employ a series of processing and algorithmically driven steps to detect churn candidates. A subset of all web activity data may be collected and then refined into web user behavioral features, including web page visits recorded as cookie identifiers (cookie_id and impression_date). These signals are then processed by machine learning algorithms to measure user churn. The model continually improves its accuracy based on new data sources, such as identifiable repeat visits (as cookie creation, and re-access) and shifts in market trends such as changes in web page content and combined together to yield the website churn data. The measurement of potential customer churn can be determined in near real-time, on demand by the client and viewed in the client dashboard upon request. depicts an example of a dashboard and results viewable by a user or client.

Unlike existing internally driven churn-based solutions which require complex integrations, the described systems and techniques are very simple to deploy and do not require service providers to share any sensitive customer data. The Client Web Solution leverages the Churn Measurement Solution to assess the performance of each client's website, digital advertising, or any other web platforms that they wish to track. For example, the client may install a pixel onto their web platform that provides the solution with device activity data. The activity data may then be linked to the DeviceClusterGraph which in turn is linked to the measured churn information. Connecting web activity to churn information gives the client a sales feedback loop which can be used to optimize their strategy for the web platform.

While various aspects of the described system and techniques have been described in reference to the FIGs. above, as noted, many changes can be made without departing from the spirit and scope of the disclosure. For example, various processes and sub-processes have been described in the context of the cellular communications industry; however, the system and methods described herein may be useful in any number of competitive industries where clients desire increased certainty and information related to customer churn. Other industries include, for example, other forms of telecommunications companies, such as Internet Service Providers (e.g., Comcast) and Cable Service Providers (DirectTV). In these applications, the “Device” shifts to an alternate format such as a Personal Computer or Television. However, the described systems and techniques are not limited only to telecommunications. Other churn focused industries such as financial services, banking, gaming, and software as a service are also applicable.

What is claimed is:

1. A method comprising the steps of:
electronically gathering, from at least one independent data source, a set of data points, wherein the data points comprise information about the behavior of a population of mobile-device customers and potential mobile-device customers;
determining a numerical score for the mobile-device customer or potential mobile-device customer based on the information; and
comparing the determined numerical score to one or more predetermined numerical thresholds, and based on the comparing, determining the mobile-device customer's or potential mobile-device customer's likelihood to churn and whether the mobile-device customer or potential mobile-device customer should be the target of emphasized marketing efforts.

2. The method of claim 1, wherein determining the mobile-device customer or potential mobile-device customers likelihood to churn is further based on at least one of one or more temporal events or one or more time constraints for service provider preferences within an adjustable window of time associated with mobile-device customer or potential mobile-device customer behavior.

3. The method of claim 1, wherein the at least one independent data source comprises a pixel, wherein the pixel is associated with a location, and wherein the pixel is configured to send an indication when a mobile-device customer or potential mobile-device customer visits the location.

4. A method for predicting churn based on multiple independent data sources, the method comprising:
collecting a plurality of data inputs, the plurality of data inputs including at least carrier identifying information, device identifying information, and churn activity information;
comparing the device identifying information and the churn activity information to determine that a known device has engaged in churn activity and outputting a potential churn event based on the comparing;
comparing the carrier identifying information with the churn activity and outputting a compensation factor based on the comparing; and
combining the potential churn event and the compensation factor to produce a churn prediction.

5. A system for measuring mobile-device customer behavior, comprising:
at least one server, wherein the at least one server further comprises
a processor;
a data bus, wherein the data bus is configured to receive inputs to the system, wherein the inputs to the system comprise at least one of environmental data, behavior data from two or more independent sources, device data including a mobile-device customer's current mobile device characteristics and available and upcoming mobile devices as announced by vendors, service providers or industry reviews, and advertising data;
a storage device bidirectionally coupled to the data bus, wherein the storage device stores at least the total of the inputs, and wherein the total of the inputs further comprises a dataset, and wherein the dataset is updated with information from the available inputs;
a non-transitory computer-readable medium embodying computer code, the non-transitory computer-readable medium being coupled to the data bus, the computer program code comprising network instructions executable by the processor and operable to enable the processor to perform the operations of:
cleaning the stored datasets, wherein cleaning the stored dataset produces a data structure; and
measuring mobile-device customer behavior using the data structure to predict mobile-device customer churn probability; and
a display, wherein the at least one server is coupled to the display, wherein the measured mobile-device customer behavior is graphically output via the display.

6. The system according to claim 5, wherein the data bus is configured to received additional inputs, wherein the additional inputs are added to the model to enhance prediction of mobile-device customer churn probability based on geographic location, and wherein the additional inputs further comprise at least one geographic location indicator, wherein the at least one geographic location indicator comprises at least one of a mobile-device customer being present in a service provider store or value-added reseller, and geographic location data, where geographic location data may be indicated by one or more of: a mobile device network location, a mobile device network WiFi provider location, a mobile device application tracking event, and a mobile device text message (SMS or MMS) that upon receipt or actionable intent (tapping a provided link).

7. The system according to claim 5, wherein the inputs or the additional inputs further comprise a mobile device application installation indicating interest in churning or upgrading a device or service plan.

8. The system according to claim 5, wherein the dataset is continuously updated with information from the available inputs.

9. A system for determining information about users, comprising:
a first database, wherein the first database comprises mobile device identifying information;
a second database, wherein the second database comprises unique mobile device identifiers;
a pixel placed on a target, wherein the pixel produces a pixel indication of whether a cookie identifier has been exposed to the pixel;
a device cluster graph communicatively coupled with the first database and the second database and comprising device cluster information derived from the mobile device identifying information and the unique mobile device identifiers, and wherein in response to a request, information is sent from the device cluster graph, including the pixel indication, to a comparison module, wherein the comparison module determines if the pixel indication is from a device associated with data stored in the device cluster graph;
a churn prediction module, wherein the churn prediction module receives the output from the comparison module and combines the output with other unique mobile identifiers that match the output; and
an output, wherein the combined data is output onto a client dashboard, indicating whether a user associated with the unique mobile identifier is likely to churn.

10. The system according to claim 9, further comprising a display, wherein the display is configured to generate the client dashboard, wherein the client dashboard is accessible remotely, and wherein the client dashboard indicates whether a user associated with the unique mobile identifier is likely to turn further comprises.

11. A method comprising the steps of:
generating device detail lookup tables, wherein the lookup tables comprise device specific bitstream data and third-party SDK device data;
generating a carrier prediction model, wherein the carrier prediction model determines the carrier associated with a device;
determining device clusters with new device information, the device cluster classifying unique devices, wherein a unique device is identified as corresponding to a specific user;
processing, by a machine learning algorithm, the device detail lookup table data churn pairs, carrier prediction model data, and cluster data; and
generating a data set from the machine learning algorithm, wherein the output represents final churn pairs, the final churn pairs representing a subscriber churn likelihood.
